(19) United States
(12) Patent Application Publication
(10) Pub. No.: US 2018/0052713 A1
(43) Pub. Date: Feb. 22, 2018

(54) Method and Apparatus for Optimizing System Resource Availability by Heuristically Transforming Raw Purchase Data into License Inventory

(71) Applicant: FLEXERA SOFTWARE LLC, Itasca, IL (US)

(72) Inventors: Matthew L. MARNELL, Boulder, CO (US); Paul HUGHES, Box Hill (AU)

(21) Appl. No.: 15/242,178

(22) Filed: Aug. 19, 2016

(51) Int. Cl. G06F 9/50; G06N 99/00

(52) U.S. Cl. CPC G06F 9/5027; G06Q 2220/18; G06N 99/005

(57) ABSTRACT

Raw purchase data is heuristically transformed into license inventory. Raw purchasing data is received at an optimization engine. The raw purchasing data typically contains four key fields: SKU (aka Part Number), Publisher/Vendor, Description, and Quantity. Strings within this raw purchasing data are tokenized, weighted, and categorized using a language context sensitive algorithm. Learning is supervised via content packs. Composite categorizations are used as input to the products user rights library (PURL) to generate a set of completely configured licenses, even in the absence of valid SKU information. Categorizations can be adjusted or corrected by users and can be applied to only that instance, to every row for that publisher, or only in some specific context. Adjustments are fed back to the system for consideration as updated training data content. Licenses update dynamically as training data improves.

### FIELD

The invention relates to data processing. More particularly, the invention relates to a method and apparatus for optimizing system resource availability by heuristically transforming raw purchase data into license inventory.

### BACKGROUND

Use rights management systems, such as Flexera's FlexNet Manager Suite provide entitlement-based license management and software license optimization to enable organizations to reduce ongoing software licensing costs and maintain continuous license compliance. For example, the FlexNet Manager Suite includes next generation software asset management and license optimization solutions that analyze inventory, application usage, purchase order data, license entitlements, and contract terms to optimize license consumption for server software. By automating the process of optimizing software license management for key vendors, systems such as the FlexNet Manager Suite products enable organizations to save on license purchases, audits, renewals, and annual true-ups, while reducing time and effort. These optimization solutions enable organizations to implement multiple software license management and contract optimization strategies that save time, help ensure continuous license compliance and reduce costs by:
Applying license entitlements: Product use rights optimize license consumption based on contractual agreements. Use rights include: upgrade, downgrade, right of second use, multiple use, roaming use, virtual use, and license mobility, among others.
Using license prioritization to drive intelligent allocation and minimize license consumption.
Tracking detailed usage of SAP software to automatically determine the optimal Named User License type for each user.
Optimizing the license count and application mix for engineering applications that use a concurrent license model.
Analyzing cloud usage trends for better budgeting and forecasting, improving efficiency, optimization of instance types, and reducing expenditures on cloud services.

In such systems, critical information, such as the SKUs, clearly defines the way a piece of software was acquired and the associated rights and limits of use. For example, when valid SKUs are available, the system can quickly and accurately determine the correct license entitlement configuration to apply based on the raw entitlement purchase data. This allows the overall system to work very well. However, when information, such as valid SKUs, is not available then nothing is available with which to process raw purchase data quickly. This often happens because purchasing data is disparate and inconsistent. A significant amount of customer purchase data is either missing information, such as SKUs, or contains other ambiguous data. This adds weeks, sometimes months, to initial implementation timelines, and greatly increases the ongoing maintenance demands of the system. As such, deployment and use of otherwise available system resources, such as the statement of licensed applications in use, is limited and system resource availability is thereby degraded.

### SUMMARY

In embodiments of the invention, use rights management systems, such as Flexera's FlexNet Manager Suite Cloud and FlexNet Manager Suite On Premises include an Application Recognition Library (ARL), a SKU (stock keeping unit) Library, and several Product Use Rights Libraries (PURLs). The ARL is the repository for the FlexeraID that is used to relate application records between FlexNet Manager Suite, AdminStudio, and App Portal. The FlexNet Manager Suite transforms raw inventory data into applications automatically via the ARL and includes comprehensive technologies to normalize SKUs into licenses with specific use rights and rules via the SKU and PURLs. That is, embodiments of the invention automatically enable system resources that are not available due to corrupt and/or incomplete system data regarding these resources. The invention solves the problem of enabling these latent resources, thus improving the functioning of the overall system.

Embodiments of the invention provide a method and apparatus for optimizing system resource availability by heuristically transforming raw purchase data into license inventory. In embodiments of the invention, raw purchasing data is received at an optimization engine. In embodiments of the invention, the raw purchasing data typically contains four key fields:
SKU (aka Part Number)
Publisher/Vendor
Description
Quantity

Strings within this raw purchasing data are tokenized, weighted, and categorized using a language context sensitive algorithm. Learning is supervised via content packs. Composite categorizations are used as input to the Product Use Rights Library (PURL) to generate a set of completely configured licenses, even in the absence of valid SKU information. Categorizations can be adjusted or corrected by users and can be applied to only that instance, to every row for that publisher, or only in some other specific context. Adjustments are fed back to the system for consideration as updated training data content. Licenses update dynamically as training data improves. In this way, system resource availability is automatically optimized, thus providing immediate access to all permitted system resources, improving system utilization, availability, and throughput, and optimizing operation of the overall system.

### DRAWINGS

FIG. 1 is a schematic block diagram of a use rights management system according to the invention;

FIG. 2 is a process flow diagram that shows how tokens are weighted, characterized, and categorized according to the invention;

FIG. 3 is a graph showing license position quality over time according to the invention; and

FIG. 4 is a block schematic diagram showing a machine in the example form of a computer system within which a set of instructions for causing the machine to perform one or more of the methodologies discussed herein may be executed.

### DESCRIPTION

Embodiments of the invention provide a method and apparatus for optimizing system resource availability by heuristically transforming raw purchase data into a sophisticated model of license entitlements. Embodiments of the invention automatically enable system resources that are not available due to corrupt and/or incomplete system data regarding these resources. The invention solves the problem of enabling these latent resources, thus improving the functioning of the overall system. In embodiments of the invention, raw purchase data is normalized. Such system automatically generates a complete initial license position, discovers and applies new patterns for each customer, ensures constant reporting readiness in future, and encourages adoption of software license optimization (SLO) best practice phased maturity improvements.

Embodiments of the invention provide a significant departure from the way that entitlement information has been analyzed in the past, which has been largely based on SKUs. In embodiments of the invention, a key change is the lexical analysis of the other key properties in this entitlement data aside from the SKU. Embodiments of the invention do not ignore SKUs, but augment existing SKU processing functionality to provide a far more complete, transparent license position.

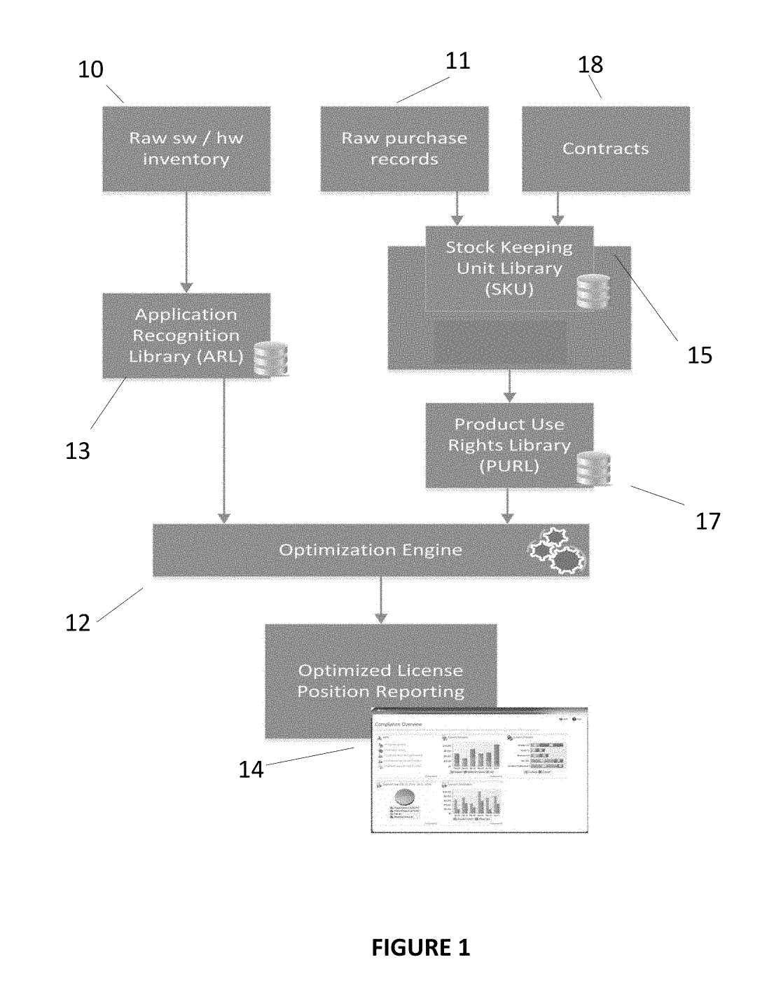

FIG. 1 is a schematic block diagram of a use rights management system, such as Flexera's FlexNet Manager Suite Cloud and FlexNet Manager Suite On Premises. Embodiments of the invention comprise an optimization engine 12 that includes an Application Recognition Library (ARL) 13, a Stock Keeping Unit Library (SKU) 15, and several Product Use Rights Libraries (PURLs) 17. The ARL is the repository for the ID that is used to relate application records between the various system modules, e.g. the Flexera ID. The optimization engine normalizes raw inventory 10 into applications automatically via the ARL and includes comprehensive technologies to normalize raw entitlement data 11 and contract data 18 via the SKU and transform that into licenses with specific use rights and rules 14 via the PURL.

In embodiments of the invention, raw purchasing data is received at the optimization engine. The raw purchasing data typically contains four key fields (although other fields can be used in connection with the practice of the invention):
SKU (aka Part Number)
Publisher/Vendor
Description
Quantity

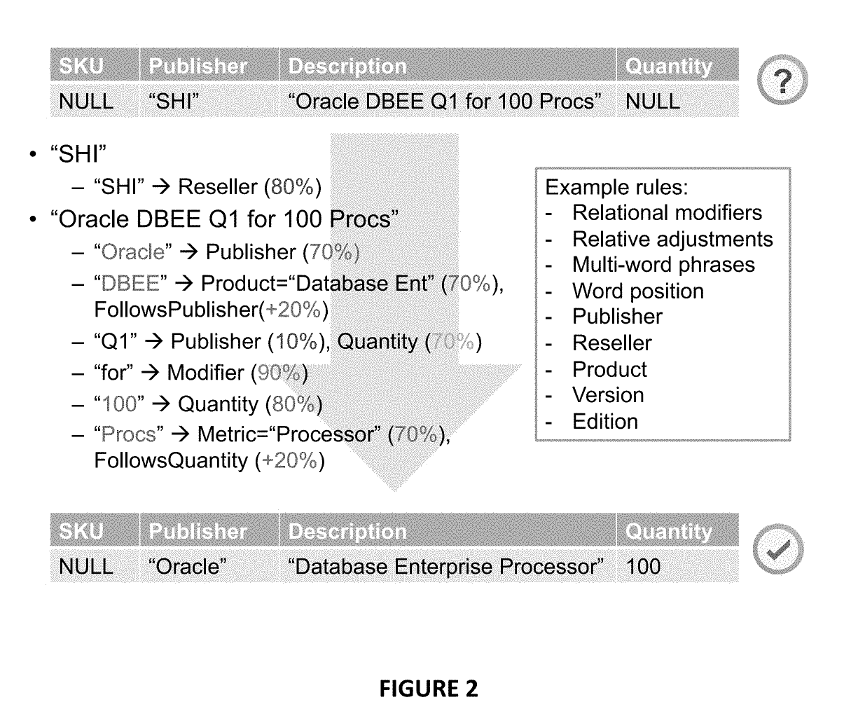

Strings within this raw purchasing data are tokenized, weighted, and categorized using a language context sensitive algorithm. Each purchase record is individually tokenized field by field. The value of each field is converted into a series of tokens using a lexical scanner. Each token contains the field from which it originated, e.g. Publisher; the type of token, e.g. word, whitespace, number; and the value of the token, e.g. “SHI”. The tokens are compared to the available set of rules which refine and normalize the records. There are several properties of the rules, but the keys are the patterns, weightings, and normalized values. Simple patterns may only use direct matching of a string on a single field, e.g. Reseller=“SHI”, as in the example. More complex patterns may match fuzzy patterns in one or more fields or even increase or decrease the weighting value of a new or existing match based on other matches on other fields. For example, a rule may significantly improve the weighting of a pattern match for Publisher=“Oracle” in the Description field due to other positive high confidence matches for “Database Enterprise” (a well-known Oracle product) in the Description field, or due to a positive match for a Publisher=“Oracle” pattern in the Publisher field. The lexical analysis of the multiple fields requires analyzing tokens using contexts within and across the various available fields. Many different patterns may be applied, but some additional examples are: SKUs, relational modifiers, relative adjustments, multi-word phrases, word position. After the rules are each checked against the purchase record, the values from the rules with the top weightings are applied to the purchase record, replacing the original values, as shown in FIG. 2.

These normalized purchase orders are used as input to the product use rights library (PURL) to generate a set of completely configured licenses. Even in the absence of valid SKU information, these normalized purchase records can now be used as productive input to PURL processing.

Learning is supervised via content packs. The system is capable of applying a wide variety of patterns and rules. These patterns and rules can be created, edited, deleted, and ignored by end users of the system. This allows them to adjust existing rules and create entirely new rules and patterns as needed to accommodate the shape of their data. If a user wants to adjust existing rules or create their own rules, they may do so. The rules can be adjusted or corrected by users and those corrections can be applied to only a single instance of a matching rule, to every purchase record for that same publisher, that same contract, or some other specific context. Adjustments are fed back to the system for consideration as updated training data content. The adjustments made by users are periodically transmitted back to an administration facility for review and incorporation into subsequent content pack releases back to customers by the administration facility. Revised sets of rules are periodically made available for download by the system. When a new content pack release is available, that content pack is downloaded by the system and the updated set of rules is applied automatically during the next purchase data processing cycle. As happened with previous processing cycles, any purchases with new or adjusted rule matches are updated automatically by the system. Licenses may update dynamically as training data improves.

FIG. 2 is an example process flow diagram that shows how tokens are weighted based on pattern matches to the rules applied by the optimization engine. The percentages shown are very significant. They are the confidence weights that establish which of the various interpretation possibilities for each token wins. The example shown uses probability values as weights, but other value systems are possible. Many tokens might match patterns associated with multiple rules, but each rule has a different weighting that signifies how strong the connection is to that rule and whether it is a positive or negative weighting. Some rules are modifiers that adjust the weight of other rules based on secondary factors, such as the relative position of multiple tokens, or the presence of corroborating pattern matches from other related rules.

After all of the various rules are evaluated against the tokens, the values from the “winning” rules are applied to each field. In the simplified example provided FIG. 2, which does not have a SKU, this means that:
“SHI” matched up to the Reseller rule at 80% confidence. No other rules matched this token.
“Oracle” matched up to the Publisher rule at 70% confidence. No other rules matched this token.
“DBEE” matched up to the Database Enterprise Product rule at 70%. DBEE is a common abbreviation for Database Enterprise Edition. Since it immediately followed a hit on Publisher, it also matched up to the Follows Publisher rule, which added 20% confidence to the Product rule, yielding an overall 90% confidence this was a description for Oracle Database Enterprise Edition.
“Q1” is sometimes an abbreviation for a Publisher, but not very often, so it matched a 10% confidence rule for Publisher. It also matched a Quantity rule at 70% confidence.
However, “100” matched a Quantity rule at 80%, so it edged out the 70% confidence that “Q1” is the Quantity to be used in the final result.
“Procs” matched a Metric rule at 70%, but since it also matched a Follows

Quantity rule, it received a 20% positive bump in confidence for that match.

In this case, the analysis suggested that this entitlement has a high likelihood to be: Oracle, Database Enterprise Edition, Processor, 100 units, and that is what the system considers unless the end user manually adjusts the values or the rules. These standardized purchase record values are now sufficiently normalized so that they can be mapped to the license definitions in the Product Use Rights Libraries (PURLs). The PURLs are license definitions that configure the use rights settings in the system to calculate the number of license entitlements needed for each instance of a software deployment. These license definitions can be mapped directly to well-formed, high quality purchase data. SKUs are an example of a relatively high quality source of well-formed purchase data that allows for reliable mappings to license definitions. With this invention, even purchase records without SKUs can be transformed into a high quality, well-formed data source that can also be reliably mapped into an entitlement processing system such as the PURL. These mappings are also packaged up and provided as content pack updates to complete the processing pathway from raw purchase data to fully configured license record capable of automatically calculating license entitlement requirements based on the available software inventory.

In this way, all available system resources that are embodied in software that is subject to license rights are enabled. As such, system resource availability is automatically optimized, thus providing immediate access to all permitted system resources, improving system utilization, availability, and throughput, and optimizing operation of the overall system.

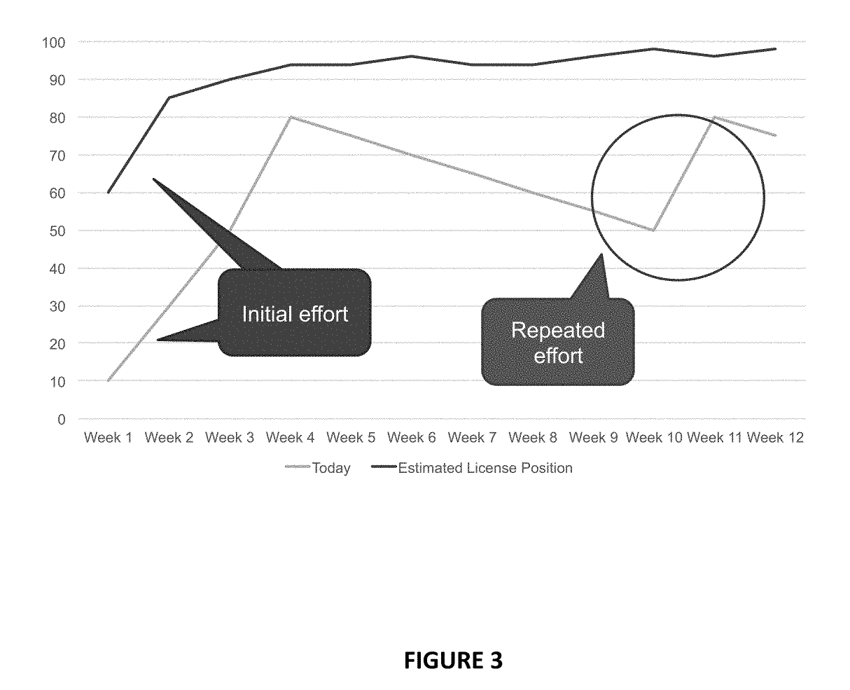

FIG. 3 is a graph showing system availability over time with and without this invention. The typical effort required to establish and maintain a license position to a sufficient level of quality such that the system can be properly used for accurate reporting is very high. Thus, it requires significant effort, often weeks or months of dedicated effort by one or more persons, to reach a minimum level of system availability. It requires significant licensing skill, experience, and time to accurately process purchase records into an accurate statement of a set of entitlements. Furthermore, new purchases are typically introduced into the system regularly, often daily, by the tens, hundreds, or thousands. Without this invention, an individual with sufficient skill, experience, and time must review each purchase record individually and make a decision about what entitlement each record represents. Without this regular effort, the quality of the license position quickly degrades and the system availability falls below acceptable levels of readiness. However, with this invention the rules constantly process new purchases and convert them to a normalized state where they can be used as reliable input to the Product Use Rights Libraries (PURLs) without regular human intervention. This keeps the system availability high, allowing for a state of reporting readiness and with relatively few unprocessed purchase records requiring human intervention.

Embodiments of the invention thus provide benefits in software license optimization, operational efficiencies and vendor management, including the ability to minimize license consumption and reduce ongoing software spend on licenses and maintenance, reduce the time and effort managing licenses and demonstrating compliance for software audits, more accurately plan and budget for future needs, minimize the risk and cost of software license non-compliance, minimize the downtime and delays due to license denials when using a concurrent license model, and gain continuous control of the software estate with a repeatable, automated best practice software asset management process.

### Computer Implementation

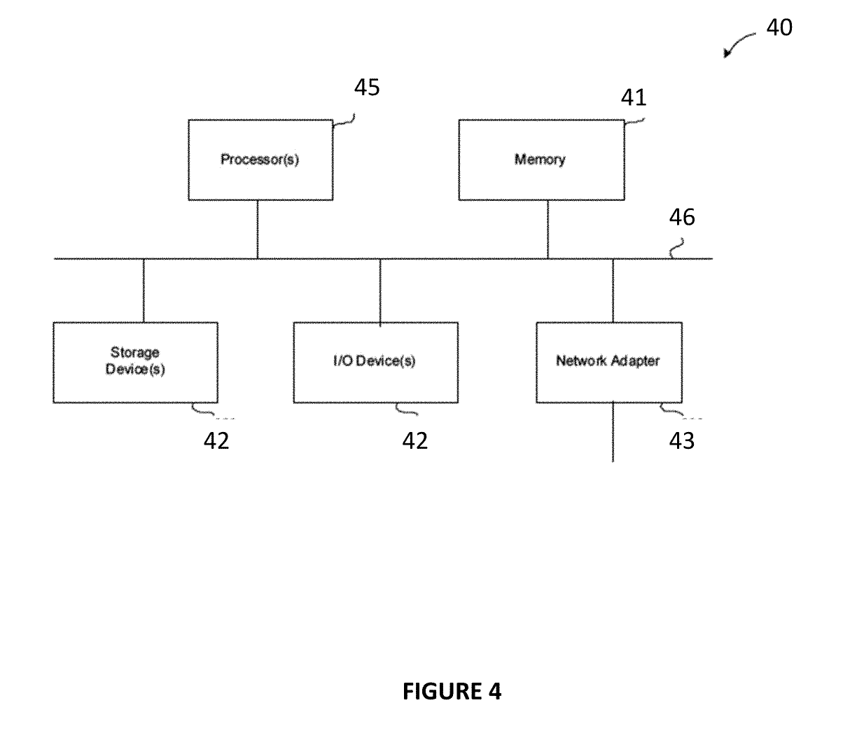

FIG. 4 is a block diagram of a computer system that may be used to implement certain features of some of the embodiments of the invention. The computer system may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, wearable device, or any machine capable of executing a set of instructions, sequential or otherwise, that specify actions to be taken by that machine.

The computing system 40 may include one or more central processing units 45, memory 41, input/output devices 44, e.g. keyboard and pointing devices, touch devices, display devices, storage devices 42, e.g. disk drives, and network adapters 43, e.g. network interfaces, that are connected to an interconnect 46.

In FIG. 4, the interconnect is illustrated as an abstraction that represents any one or more separate physical buses, point-to-point connections, or both connected by appropriate bridges, adapters, or controllers. The interconnect, therefore, may include, for example a system bus, a peripheral component interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also referred to as Firewire.

The memory 41 and storage devices 42 are computer-readable storage media that may store instructions that implement at least portions of the various embodiments of the invention. In addition, the data structures and message structures may be stored or transmitted via a data transmission medium, e.g. a signal on a communications link. Various communications links may be used, e.g. the Internet, a local area network, a wide area network, or a point-to-point dial-up connection. Thus, computer readable media can include computer-readable storage media, e.g. non-transitory media, and computer-readable transmission media.

The instructions stored in memory 41 can be implemented as software and/or firmware to program one or more processors to carry out the actions described above. In some embodiments of the invention, such software or firmware may be initially provided to the processing system 40 by downloading it from a remote system through the computing system, e.g. via the network adapter 43.

The various embodiments of the invention introduced herein can be implemented by, for example, programmable circuitry, e.g. one or more microprocessors, programmed with software and/or firmware, entirely in special-purpose hardwired, i.e. non-programmable, circuitry, or in a combination of such forms. Special-purpose hardwired circuitry may be in the form of, for example, one or more ASICs, PLDs, FPGAs, etc.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for optimizing system resource availability, comprising:
receiving, by a processor, raw data representing purchase orders defining entitlements providing availability for a plurality of system resources;
determining that said entitlements comprise latent system resources representing inactive system resources;
determining at least some of said raw data for at least some of said latent system resources comprises corrupt and/or incomplete data lacking a product SKU (stock keeping unit);
normalizing, by the processor, said raw data by lexical analysis of properties representing content of fields in said raw data;
generating tokens for each of said fields, said tokens representing a probability of meaning of said content of said corresponding fields; and
activating system resources by transforming, by the processor, said latent system resources embodied in said normalized raw data into active system resources providing availability for a plurality of system resources within an initial license inventory having specific use rights and rules based on said tokens;
wherein system resource availability is automatically optimized and immediate access to all permitted system resources is provided.

2. The method of claim 1, further comprising:
automatically transforming, using an application recognition library (ARL), said latent system resources embodied in said normalized raw data into active system resources within an initial license inventory.

3. The method of claim 2, further comprising:
providing ,using the ARL, a repository for an ID, said ID relating records between each of said ARL, an SKU library, and a plurality of product use rights libraries (PURLs).

4. The method of claim 1, wherein said raw data comprises a plurality of fields, including any of SKU, publisher/vendor, description, and quantity.

5. (canceled)

6. The method of claim 2, further comprising:
using composite categorizations from said ARL as input to said products user rights library (PURL) to generate a set of completely configured licenses.

7. The method of claim 6, further comprising:
adjusting said categorizations, wherein said adjustments are applied to any of a particular instance, to every row for a publisher, or only in some specific context.

8. The method of claim 7, further comprising:
feeding back said adjustments for consideration as updated training data content, wherein licenses update dynamically as training data improves.

9. The method of claim 1, further comprising:
applying percentages to each of said tokens, said percentages representing confidence weights that establish a preferred interpretation possibility for each of said tokens.

10. The method of claim 9, further comprising;
using said tokens for any of triggering multiple rules, where each rule has a different weight that signifies a relevance of a connection is to that rule.

11. The method of claim 9, further comprising;
using one or more rules as modifiers to adjust a weight of other rules based on secondary factors, including a relative position of multiple tokens.

12. The method of claim 9, further comprising;
evaluating a plurality of rules against said tokens; and
after each rule is evaluated, matching each key field in each said token with a preferred rule.

13. The method of claim 6, further comprising:
mapping said composite characterizations to license definitions in said PURL to configure use rights settings.

14. The method of claim 13, further comprising:
based on said mapping of said composite characterizations to license definitions in said PURL, calculating a number of license entitlements needed for each instance of a software deployment by mapping license definitions directly to purchase data.

15. The method of claim 13, further comprising:
based on said mapping of said composite characterizations to license definitions, creating one or more content pack updates to complete a processing pathway from raw purchase data to a fully configured license record that automatically calculates license entitlement requirements in view of an available software inventory.
